(19) United States
(12) Patent Application Publication
(10) Pub. No.: US 2007/0162450 A1
(43) Pub. Date: Jul. 12, 2007

(54) Query object permissions establishment system and methods

(76) Inventors: Anthony Siress, Mountain View, CA (US); Mark Fitzpatrick, San Mateo, CA (US)

Correspondence Address: PERKINS COIE LLP, P.O. BOX 2168, MENLO PARK, CA, 94026, US

(21) Appl. No.: 11/643,064

(22) Filed: Dec. 20, 2006

Related U.S. Application Data
(63) Continuation-in-part of application No. 11/397,817, filed on Apr. 3, 2006.
(60) Provisional application No. 60/668,302, filed on Apr. 4, 2005.

(51) Int. Cl. G06F 17/30

(52) U.S. Cl. 707/9

(57) ABSTRACT

Methods and systems are described for controlling query access to attributes associated with subscribers of a system. Permission setting variables are provided to allow subscribers considerable control over query access to attributes associated with the subscribers. A subscriber may manipulate one or more permission setting variables to control aspects of the response a querying party may receive when a query matches attributes associated with the subscriber. Advantages of the invention include flexible management of query access to subscriber information.

### CROSS-REFERENCE TO RELATED APPLICATIONS

The present application claims priority to U.S. Provisional Patent App. No. 60/668,302, and to U.S. patent application Ser. No. 11/397,817 which are incorporated herein by reference.

### BACKGROUND

A data entry is a data structure containing descriptive information about a corresponding entity. Examples of a corresponding entity could include but are not limited to a person, a company, a place, a church, an object. Entities are often associated with descriptive information that could include any attributes relating to the entity, including but not limited to identifying information, location, relational associations, colors, shape, size, and history. These attributes are often represented in discrete forms facilitating the storage, modification, manipulation, display, and organization of descriptive information or attributes. Such discrete forms are commonly referred to as data structures. Examples of data structures include but are not limited to arrays, heaps, lists, trees, heaps, and matrices.

Data entries are often collectively stored in computer-readable mediums or data stores, a common data store being a database. Databases are collections of data entries which are organized, stored, and manipulated in a manner specified by applications known as database managers. The manner in which database entries are organized in a database is known as the database structure. Database managers organize information in a database into records, with each record made up of fields. Fields and records may have different characteristics depending upon the purpose and functionality of the database manager. The term “database,” as used herein, describes data entries and associated database managers. Hereinafter, the term “database” is intended to include both data entries and associated database managers.

Access to data stores or computer-readable mediums is often governed or regulated by permissions. Permissions expressly or impliedly indicate which users and the degree to which those users may access a data store, set of data stores, or part of a data store. Permissions often impliedly or indirectly indicate a user's permitted access by referring to a permissions group of which the user is a member. A permissions group comprises a set of member data store users with a common degree or level of permitted access; an association with a data store, set of data stores, or part of a data store; and a definition of the common degree or level of permitted access. Permissions often indicate the degree or level of access to an associated data store, set of data stores, or part of a data store with a set of modifiable variables, a set of preset parameters, a reference to a set of modifiable variables, or a reference to a set of preset parameters specifying whether the data entries in the associated storage may be viewed, modified, deleted, or created.

Traditional systems typically define permissions in relation to a data store, set of data stores, or a part of a data stores rather than any particular data entry in a data store. Individual users whose data are stored in these entries, however, often prefer to control or regulate access to data entries associated with them on an individual basis. Specifically, a user may prefer to grant data entry access only to inquiring parties who can demonstrate some knowledge with regard to that specific user. Accordingly, there is a need for user-controlled query access to data entries.

### SUMMARY

Systems and methods are present herein for providing user-controlled query access to attributes associated with a queried user. In one exemplary embodiment, a user may select one or more query permission variables including a private status associated with the user, a searcheability requirement, and a matcheability requirement. The permission variables, alone or in combination, allow the user to maintain different levels and aspects of management over query access to attributes associated with the user. For example, a user who selects a private status retains executive control over each query request.

The proposed systems and method can offer, among other advantages, flexible query access management and security administration of individual data entries comprising user attributes.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts a conceptual view of a system for setting permissions to control query access between subscribers of the system.

FIG. 2 depicts a system 200 that provides subscribers permissions to query other subscribers based on attributes.

FIG. 3 depicts several examples of tables that may be included in a database for storing permissions settings.

FIG. 4 depicts flowchart 400 of a method for adding and/or editing the permissions and attributes.

FIG. 5 depicts flowchart 500 of a method for making a query in accordance to one embodiment of the invention.

FIG. 6 depicts a flowchart 600 of a method for facilitating user-controlled query access.

FIG. 7 depicts an exemplary system on which a framework for user-controlled query access may be implemented.

### DETAILED DESCRIPTION

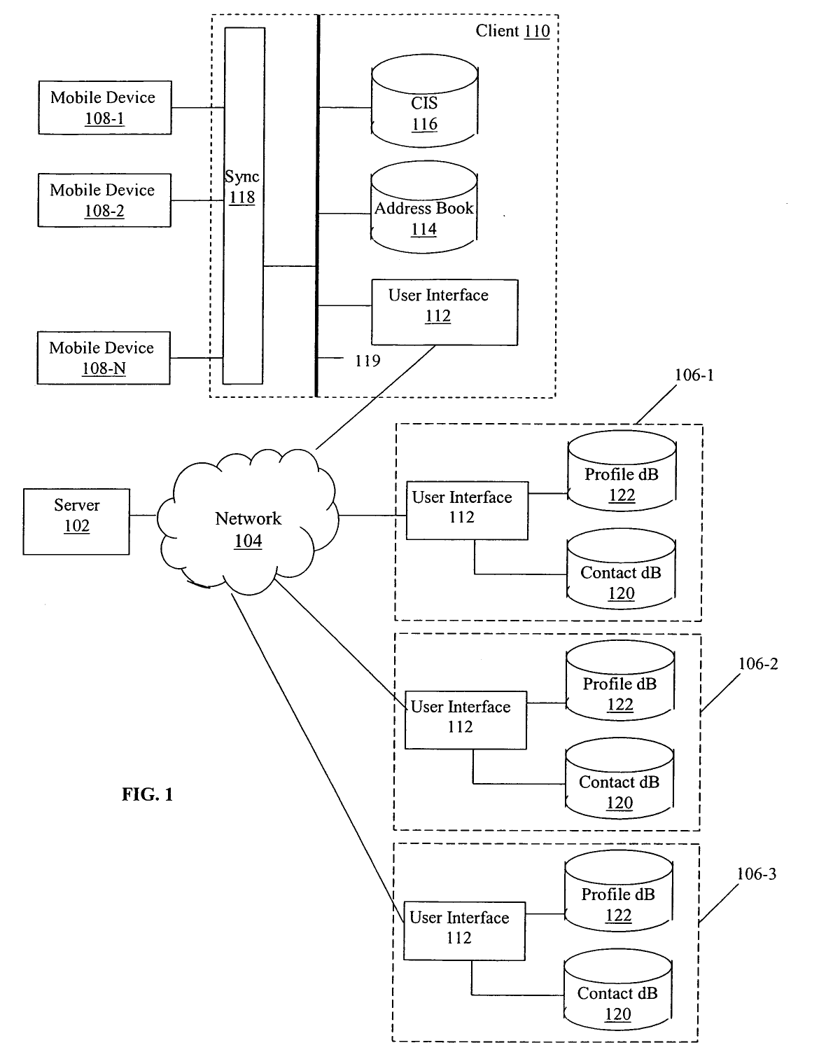

FIG. 1 depicts a conceptual view of a system for setting access permissions between subscribers of a system 100. In the example of FIG. 1, the system 100 includes a server 102, a network 104, clients 106-1 to 106-N (referred to collectively hereinafter as clients 106), mobile devices 108-1 to 108-N (referred to collectively hereinafter as mobile devices 108), and a client 110. It may be noted that the client 110 is distinguished from the clients 106 for the purposes of example only. Aspects described with reference to any one of the clients 106, 110 may be applicable to all or a subset of the clients 106, 110.

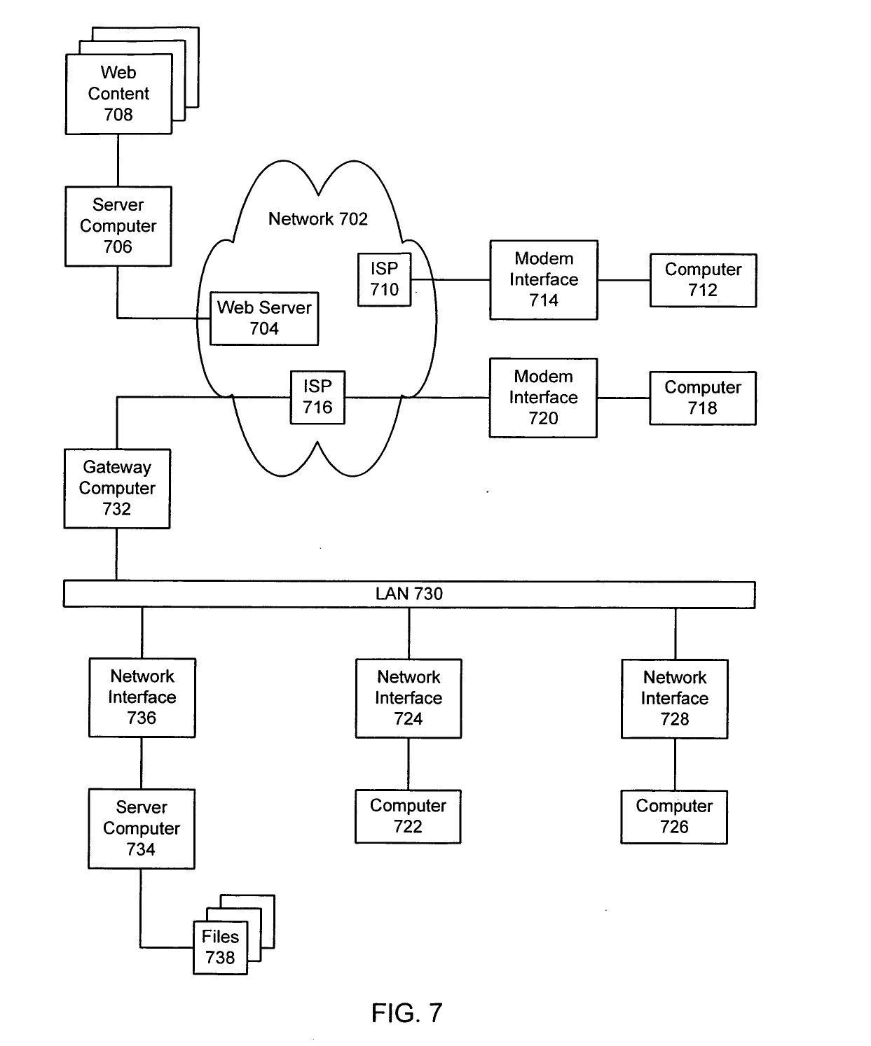

The server 102 may include various hardware and/or software components, as described later with reference to FIG. 7. The network 104 may be the Internet, or any other network, as described later with reference to FIG. 7.

The clients 106 may include various hardware and/or software components, as described later with reference to FIG. 7. In addition, in an embodiment, the clients 106 include a user interface 112 a contact database 120, and a user profile database 122. User interface 112 facilitates the interaction between the system and a subscriber of the system. The subscriber may use the interface 112 to update profile attributes or contact information. User interfaces may include, but is not limited to, a web interface, a mobile phone and the like. The contact database 120 may store information associated with a subscriber's contacts. The contact database 120 may comprise a number of data entries wherein each entry includes one or more attributes associated with a contact known to the subscriber. For example but not limitation, the attributes may include a first name, a last name, a home address, an e-mail address and the like. In another embodiment, a contact database entry may include additional attributes such as the type of contact including but not limited to a business or personal contact. The profile database 122 may include one or more attributes associated with a subscriber. For example, a profile database may comprise the subscriber's name, home address, e-mail address, favorite food, high school attended, and the like. In one embodiment, the profile database 122 may include permission control data associated with each profile attribute. Moreover, both the profile database and the contact database may be left unpopulated.

The mobile devices 108 may include various hardware and/or software components, as described later with reference to FIG. 7. Indeed, the clients 106 could be mobile devices. However, for illustrative purposes, the mobile devices 108 synch with the client 110 in a manner that is known in the computer arts. For example, the mobile device 108-1 may be by way of example but not limitation a mobile phone, and the mobile device 108-2 may be by way of example but not limitation a PDA, both of which can synch with, by way of example but not limitation, a Mac OS X Address book on a user's computer (e.g., the client 110) through an iSync mechanism, which is known in the computer arts. The client 110 would then update local databases based upon the results of the iSync. Comparable technologies exist for various address book types and various operating systems.

The client 110 may include various hardware and/or software components, as described later with reference to FIG. 7. In addition, in an embodiment, the client 110 includes a user interface 112, an address book 114, an information service database (CIS) 116, and a Sync module 118. The various components are connected to a bus 119. It may be noted that alternative embodiments that do not connect some or all of the components to the bus 119 are possible, particularly in a distributed architecture, as would be apparent to one of ordinary skill in the art of computer architecture.

In an example of operation, a subscriber is associated with the client 110. The subscriber owns the mobile devices 108 (or, at least, an owner of a mobile device has access to the sync module 118). The subscriber can update address books on the mobile devices 108 and/or the subscriber can update the address book 114 using an input. The CIS 116 may or may not be able to recognize the address books of the mobile devices 108. Recognition is not necessary if the sync module 118 can render the data in a format that is recognizable to the user interface 112.

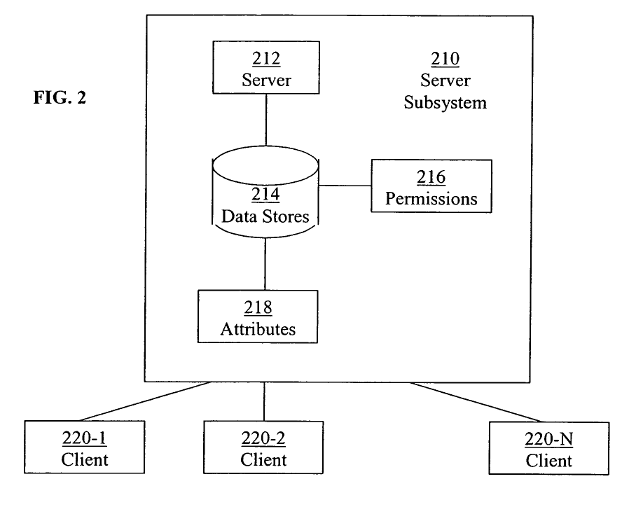

In any case, whether changes to the address book 114 are accomplished through synching the address book of one or more of the mobile devices 108 or by some other means, such as subscriber input, the user interface 112 detects the change. Then the user interface 112 performs certain tasks, such as checking permissions, as described in more detail with reference to FIGS. 2 to 6, and forwards data associated with the update, with appropriate instructions if necessary, through the network 104 to the server 102. In an embodiment, to ensure security, transactions between the client 110 and the server 102 are encrypted.

The server 102 performs tasks, described in more detail with reference to FIGS. 2 to 6, that include controlling query access to information associated with subscribers of the system 100.

In a non-limiting embodiment, the respective user interface 112 of the clients 106 periodically signal the server 102 that they are awake and/or ready to receive updates. The server 102 sends updates through the network 104 to the clients 106 that they are ready and/or allowed to receive updates. When the clients 106 receive the updates, the user interfaces 112 update their respective contact databases.

The address book 114 may have any of a variety of address book configurations. Further, the address book 114 may include any subset of computer-readable medium from a set of computer-readable mediums, which subset stores one or more identifiable sets of attributes.

In one embodiment, the identifiable attribute sets are associated with various levels of access restrictions and/or permission settings. For example, but not limitation, an entry having identification information for a wanted fugitive may comprise one or more attributes wherein a first attribute may include a name or an alias for a fugitive, a second attribute may include a facial composite sketch or a photo of the fugitive, a third attribute may represent the factual details of the crime(s) the fugitive has allegedly committed, and a fourth attribute may represent encrypted terrorist connections relevant to the fugitive. In this example, the first attribute may be accessible to the subscribers of a client 106 or 110 located in states where the fugitive is expected to be in hiding; the second attribute may be accessible to all users of a client 106 or 110; the third attribute may be accessible only to users of a client 106 or 110 who can provide identification verification of a law enforcement member with appropriate security clearance; and the fourth attribute may be accessible only to government officials who may have access to a client 106 or 110.

In one embodiment, any entry or listing stored in the address book 114 can be identified through one or more values of at least one attribute in a corresponding attribute set. The one or more values may include, by way of example and not limitation, a social security number, employee number, email address, a phone number, digitized fingerprint representation, dossier number, license plate number, case number, and the like. Further, the one or more values may or may not uniquely identify an entry or listing and may comprise any format or representation including, by way of example and not limitation, alphanumeric strings, hexadecimal numbers, bit strings, JPEG images, MP3 files, or any other known or eventual data format.

The address book 114 may include, but is not limited to, an internet portal e-mail address book, Microsoft Outlook® address book, a social network contact book, and the like. Moreover, the address book is optional and may or may not contain any contact information.

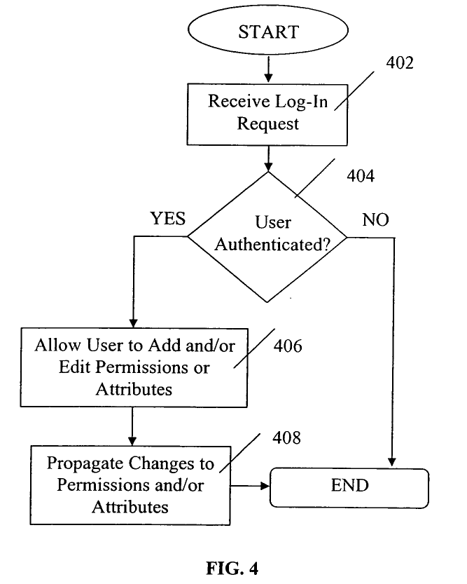

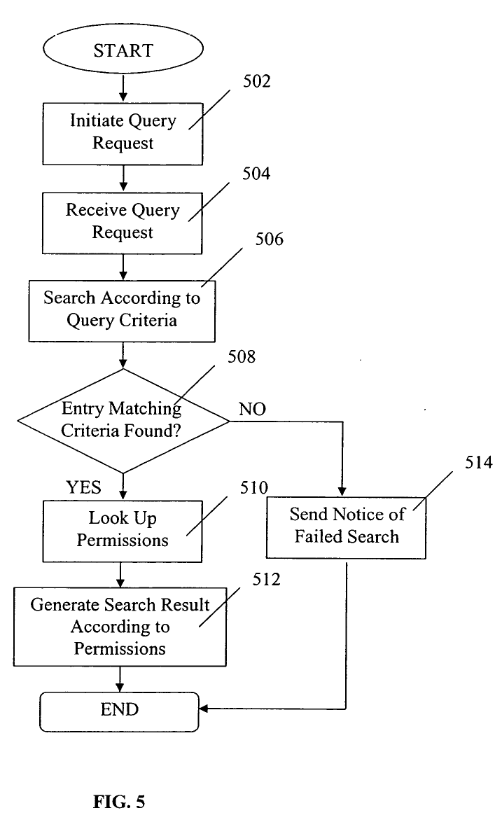

The CIS 116 includes data related to various address book types with which the user interface 112 is configured to synch. In an embodiment, adding a new address book type to the CIS 116 does not result in the need for recompilation or other reconfiguration of the user interface 112. In another embodiment, no recompilation or other reconfiguration of the user interface 112 is necessary when the address book 114 (or a contact database of one of the mobile devices 108 or clients 106) is changed from one address book type to another or when the address book 114 is upgraded to a new version. The sync module 118 facilitates synching of the mobile devices 108 with the client 110 in a manner that is known. The user interface 112 detects updates accomplished by the sync module 118 and performs appropriate actions, as described in more detail with reference to FIGS. 4 and 5 in U.S. patent application Ser. No. 11/397,817, which is incorporated herein by reference.

In one operational embodiment, a subscriber may query address books on the mobile devices 108 and/or the address book 114 using a known or convenient input device. The user interface 112 then performs certain tasks including, but not limited to, checking permissions and forwarding data associated with the query through the network 104 to the server 102. In one embodiment, the transactions between the client 110 and the server 102 are encrypted. The server 102 then performs tasks including, but not limited to, distributing the query data to the user interface 112 of the clients 106 and/or 110; requesting permissions data and/or attributes data from the user interface 112; and/or evaluating the query data in light of the permissions data and/or the attributes data associated with one or more subscribers. In one embodiment, when a client 106 and/or 110 receives the query data, its respective user interface 112 evaluates the query data in light of its associated permissions data and/or attributes data. Based on the outcome of the evaluation, the client 106 and/or 110 may, by way of example and not limitation, send a result to the server 102, the subscriber who initiated the query, and/or an internal transaction log. The user interface 112 may or may not also alter its permissions to enable the subscriber to receive, update, and/or access the attributes of the respective client 106 and/or 110.

In a second operational embodiment, a subscriber may query address books on the mobile devices 108 and/or the address book 114 and the server 102 may perform some or all of the query data evaluation before and/or after it sends the query data to the clients 106 and/or 110. Based on the evaluations, the server 102 may, by way of example and not limitation, send a result to the clients 106 and/or 110, the subscriber who initiated a query, and/or an internal transaction log. The server 102 or the user interface 112 may or may not alter the permissions of the clients 106 and/or 110 to enable the subscriber to receive, update, and/or access the attributes of the respective client 106 and/or 110.

In a third operational embodiment, a subscriber may query address books on the mobile devices 108 and/or the address book 114 and the server 102 may request the permission data and/or attributes data from the clients 106 and/or 110 when the clients 106 and/or 110 signal that they are ready to receive a query request. When the clients 106 and/or 110 receive the request, the respective user interface 112 may or may not authenticate the request. If the user interface 112 authenticates the request, it sends the permissions data and/or attributes data to the server 102 according to the request. If the server 102 receives the permissions data and/or attributes data, it evaluates the query data in light of the permissions data and/or attributes data. Based on the evaluation, the server 102 may, by way of example and not limitation, send a result to the clients 106 and/or 110, the subscriber who initiated a query, and/or an internal transaction log. The server 102 or the user interface 112 may or may not alter the permissions of the clients 106 and/or 110 to enable the subscriber to receive, update, and/or access the attributes of the respective client 106 and/or 110.

In a fourth operational embodiment where the server 102 has a local copy of all permissions and attributes data associated with the clients 106 and/or 110, a subscriber may query address books on the mobile devices 108 and/or the address book 114 and the server 102 may evaluate the query data in light of the permissions data and/or attributes data. Based on the evaluations, the server 102 may send a result to the clients 106 and/or 110, the subscriber who initiated a query, and/or an internal transaction log. The server 102 or the user interface 112 may or may not alter the permissions of the clients 106 and/or 110 to enable the subscriber to receive, update, and/or access the attributes of the respective client 106 and/or 110.

It will be recognized that the four operational embodiments above are intended to illustrate techniques by way of example and not limitation. For example, the embodiments may be combined wholly or in part into a single embodiment. Moreover, alternative methods may be employed in a system suitable to carry out the embodiments described above. An exhaustive list of all combinations and permutations of embodiments has not been attempted here but one skilled in the relevant will recognize alternative embodiments based on those methods described above.

It will be noted that the client 110 is distinguished from the clients 106 for illustrative purposes only. Further, elements of the client 110 serve as illustrative embodiments of elements shown in clients 106. For example, the address book 114 serves as an example of a contact database 118 and may be implemented as a proprietary database such as a Yahoo® e-mail address book or an internal contact list customized for the system 100. Similarly, the CIS 116 may be an exemplary embodiment of the profile database 120 and may comprise, among other things, attributes associated with a subscriber and/or permission settings. In other embodiments, an address book and/or a CIS are optional or left unpopulated.

FIG. 2 depicts a system 200 that provides permissions for query access control based on attributes. Further, the system 200 allows queried subscribers discretionary control over query permissions associated with the subscribers' attributes data. The system 200 may or may not be similar to the system 100 depicted in FIG. 1. In the example of FIG. 2, the system 200 includes a server subsystem 210 and clients 220.

In the example of FIG. 2, the server subsystem 210 further comprises a server 212, one or more data stores 214, one or more permission sets 216, and one or more attribute sets 218. The server 212 may include various hardware and/or software components. The server 212 may or may not comprise one or more “servers” as this term is often interpreted by those skilled in the art. In one embodiment, the server 212 comprises one or more computer-readable mediums. One of skill in the relevant art will immediately recognize that the terms “machine-readable medium” or “computer-readable medium” include any type of storage device that is accessible by a processor and also encompasses a carrier wave that encodes a data signal. By way of example and not limitation, the server 212 may comprise handheld devices, multiprocessor systems, microprocessor-based or programmable consumer electronics, network PCs, minicomputers, mainframe computers, wireless devices, and the like. The server 214 may also comprise one or more distributed computing environments where tasks are performed by remote processing devices linked through a communications network.

The server 212 is coupled to the one or more data stores 214. In one embodiment, the data stores 214 may be internal to, directly connected to, and/or a part of the server 212. In another embodiment, the data stores 214 may be separate or remote from the server 212 and may communicate to the server 212 through a network such as the network 104 illustrated in FIG. 1. The data stores 214 comprise one or more computer-readable mediums. One of skill in the art will recognize that the terms “machine-readable medium” or “computer-readable medium” include any type of storage device that is accessible by a processor and also encompasses a carrier wave that encodes a data signal. In one embodiment, the data stores 214 may comprise an SQL database that stores subscriber information, the attribute sets 218, the permission sets 216, and a transactions log for the system 200.

The permission sets 216 controls what attribute sets 218 a subscriber of the system 200 will share with other subscribers, what attribute sets 218 a subscriber will enable other subscribers to query, whether other subscribers will receive contact information of a subscriber who matches a query request, and the content of query requests a querying party will receive. In one example where a first subscriber has his permission sets 216 configured such that the first subscriber can receive a second subscriber's home email, the first subscriber will receive the current value of the second subscriber's home email if the second subscriber has configured his permission sets 216 to allow the first subscriber to receive this information. In a second example where a first subscriber is searching for all subscribers whose attribute sets 218 indicate that they attended a particular high school, the first subscriber will only receive results including subscribers who have configured their permission sets 216 to allow other subscribers to query by that attribute. Alternatively, subscribers who attended that high school and have allowed other subscribers to query by the high school attribute may allow the first subscriber to receive the second subscriber's name and some means of contact such as an email address, an instant messaging user name, or a telephone number.

The permission sets 216 may include variables comprising sets of locations in at least one computer-readable medium such as the data stores 214 to which one or more identifiers refer. Any arrangement or structure of these sets of locations could be used to store the variables. Such arrangements or structures are often referred to as data structures, which may include but are not limited to arrays, heaps, lists, trees, matrices, words, bytes, and or bits. The computer-readable medium locations referred to by the permissions variables or data structures may comprise data or values of any format or representation type, including by way of example but not limitation, alphanumeric strings, hexadecimal numbers, bit strings, JPEG images, MP3 files, or any other known or eventual data type. The data or values may also comprise indirect references to other values such as, by way of example but not limitation, an address for locating another value, an encrypted value, and/or any other known or eventual indirect reference to a value.

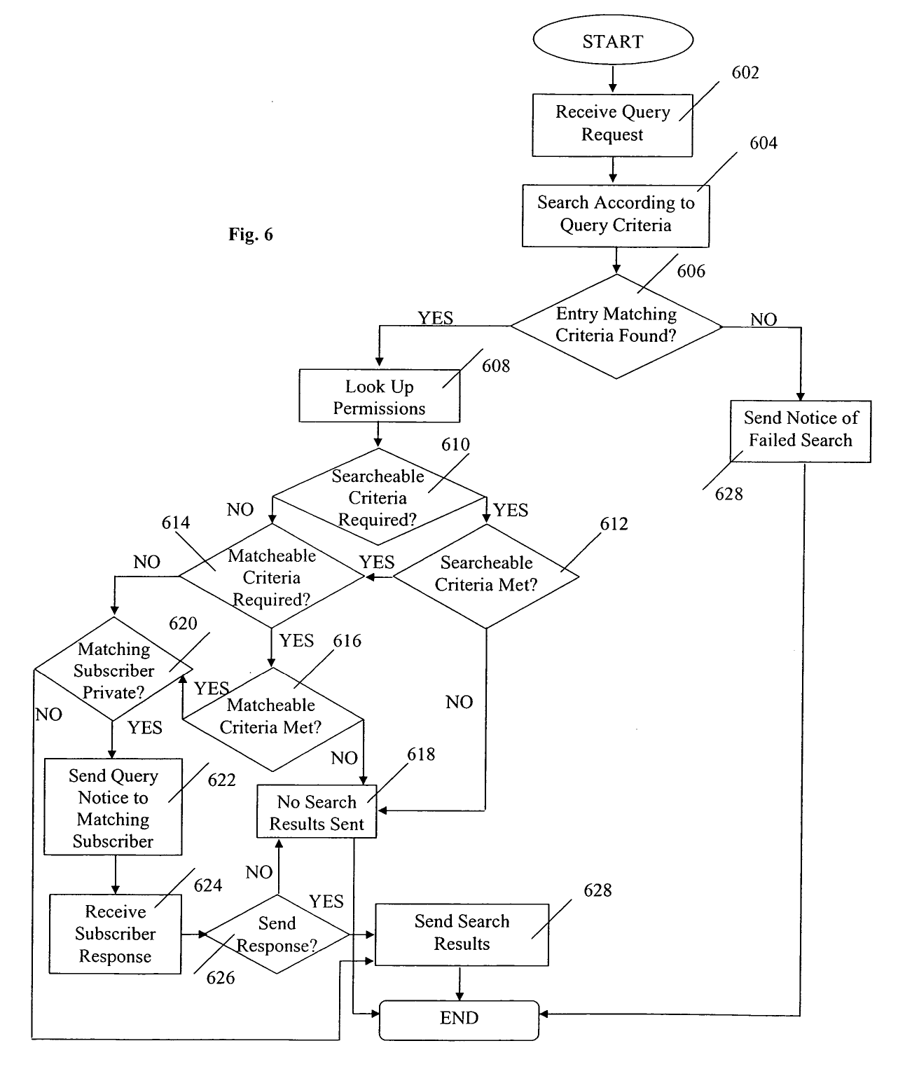

The attribute sets 218 comprise entries having attributes associated with the subscribers of the system 200. The attributes may include, but not limited to, first name, last name, anniversaries, home address, business address, home phone number, home fax number, cell phone number, business phone number, email addresses, wish lists, clothing sizes, favorite colors, favorite foods, and the like. Each attribute in the attribute sets 218 may correspond to one or more permissions settings in the permission sets 216. A subscriber may manipulate permissions in various configurations in order to restrict the distribution of attributes associated with the subscriber. For example, a subscriber may divide the attributes into categories such as personal and business and designate other subscribers known to the subscriber as a personal or business contact. Consequently, the subscribers designated as personal contacts are granted permissions to the personal attributes whereas the business contacts will have access only to the business attributes. In another example, a subscriber may set the permissions associated with an attribute such that a designated one or more other subscribers will be updated when the subscriber changes the content or value of the attribute. Further, a subscriber may set permissions to restrict what other subscribers will receive if the subscriber's attributes match the query criteria. For example, the subscriber may select a private status to receive notice of search queries matching the subscriber's attributes and decide whether the querying parties will receive any result from the subscriber. The method for setting query permissions will be discussed in detail with reference to FIGS. 5 and 6.

The clients 220 may comprise any hardware and/or software structure, architecture, or components the clients 106 and 110 in FIG. 1 may comprise.

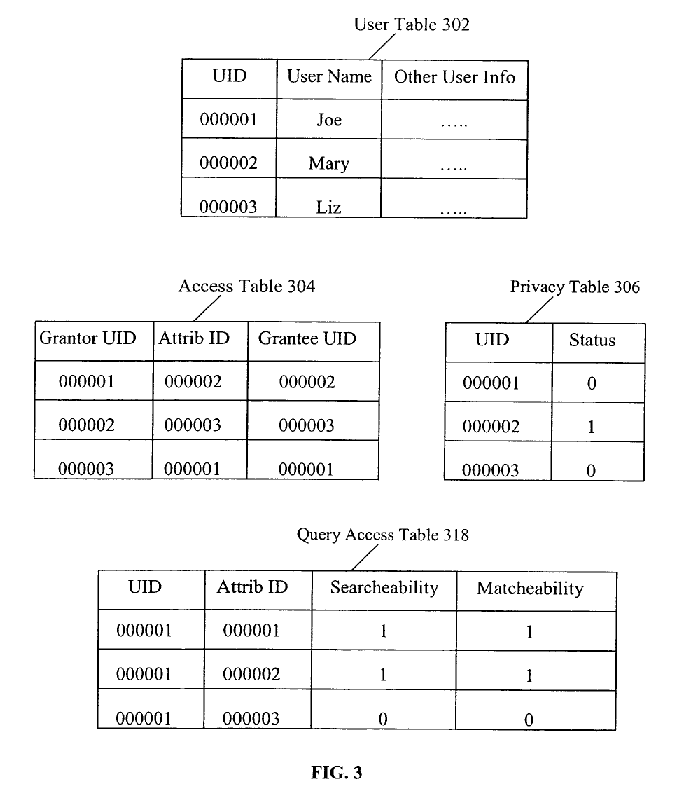

FIG. 3 depicts several examples of tables that may be included in a database for storing permissions settings, such as the data stores 214, according to an embodiment. The tables include a user table 302, an access table 304, a privacy table 306, and a query access table 308.

In the example of FIG. 3, the user table 302 includes the fields UID, user name, and other user information. The user table 302 is an illustrative embodiment of a set of attributes which the attribute sets 218 in FIG. 2 may comprise. The user table 302 may comprise a number of attributes including, but not limited to, user name, anniversaries, home address, business address, home phone number, home fax number, cell phone number, business phone number, email addresses, wish lists, clothing sizes, favorite colors, favorite foods, and the like.

In the example of FIG. 3, the access table 304 includes the fields grantor UID, attrib ID, and grantee UID. In one embodiment, a subscriber identified by a grantor UID grants a second subscriber identified by a grantee UID access to certain attributes identified by the attrib ID. In the example of FIG. 3, for instance, a first subscriber identified by the grantor UID 000001 allows a second subscriber identified by grantee UID 000002 access to the first subscriber's attribute identified by attrib ID 000002. In one embodiment, if a grantor has granted a grantee access to certain attributes, the grantee has query access to those attributes. In another embodiment, if a grantor has granted a grantee access to certain attributes, the grantee receives updates of those attributes when the grantor makes any changes to the attributes. The attributes identified by the attrib ID may include any information including, but not limited to, user name, anniversaries, home address, business address, home phone number, home fax number, cell phone number, business phone number, email addresses, wish lists, clothing sizes, favorite colors, favorite foods, and the like.

In the example of FIG. 3, the privacy table 306 includes the fields UID and status. The UID is used to identify a subscriber and the status field indicates the subscriber's privacy selection for query permissions. In the embodiment in FIG. 3, the privacy status is shown in a binary format wherein a “1” selection indicates a subscriber who wishes to retain control over query access and a “0” selection indicates a subscriber who does not require direct control over every query access. The binary format is illustrative and not intended to be limiting. In other embodiments, more or fewer levels of privacy may be implemented using other representations including, but not limited to, numerical or hexadecimal data formats. The privacy status is described in detail with reference to FIG. 6.

In the example of FIG. 3, the query access table 308 includes the fields UID, attrib ID, searcheability, and matcheability. The UID identifies a subscriber and the attrib ID identifies an attribute associated with the subscriber. The searcheability and matcheability fields indicate different levels of query accessibility to an attribute according to a subscriber's permission settings. In one embodiment, a searcheable attribute is an attribute that can be used to query a subscriber whereas a matcheable attribute is an attribute that must be included in the query to receive result associated with the subscriber. Further, in the embodiment shown in FIG. 3, the searcheability and matcheability fields are shown in a binary format wherein a “1” indicates an attribute is searcheable or matcheable, respectively. Alternatively, a “0” indicates that an attribute cannot be used as a searcheable attribute and/or cannot be used to fulfill a matcheable criterion, respectively. The binary format is illustrative and not intended to be limiting. The fields searcheability and matcheability are exemplary, more or fewer permission settings may be implemented to restrict query access. The application of searcheable and matcheable attributes to control query access is described in detail with reference to FIG. 6.

FIG. 4 depicts flowchart 400 of a method for adding and/or editing the permissions and attributes associated with subscribers of a system such as that illustrated in FIG. 2. In an embodiment, the flowchart 400 starts at module 402 wherein a log-in request is received at a server. The server may be any server configured to allow permissions control, including server 102 in FIG. 1. A subscriber may input a log-in request using any known and/or convenient devices such as those described with reference to mobile device 108 in FIG. 1.

In an embodiment, the flowchart 400 continues at decision point 404 where the server checks whether the log-in request can be authenticated. If the request does not include data matching those of a subscriber to the system, the user is denied access to the system (404-NO). Alternatively, if the request comprises data matching those of a subscriber, the user is authenticated as a system subscriber (404-YES) and the flowchart 400 continues at module 406 where the subscriber may add and/or edit the permissions or attributes associated with the subscriber. The permissions and attributes may be of any format discussed with reference to FIG. 2. Exemplary methods for adding and/or editing the permissions or attributes are described with reference to FIG. 5 in U.S. patent application Ser. No. 11/397,817, which is incorporated herein by reference. In one embodiment, a subscriber adds or edits a set of permissions applicable to one or more other subscribers known to the subscriber as contacts. For example, a subscriber may add a new phone number and allow contacts in the subscriber's address book access to that phone number. The subscriber's address book may be stored in any format including those discussed with reference to address book 114 in FIG. 1. In another embodiment, a subscriber adds or edits the permissions associated with queries including, but not limited to, the subscriber's privacy status as shown in table 306 of FIG. 3, and/or the query accessibility as shown in table 308 of FIG. 3.

In an embodiment, the flowchart 400 continues at module 408 where the changes to permissions and attributes are propagated to data storage such as the data stores 214 in FIG. 2. Exemplary methods for propagating changes to the permissions or attributes are described with respect to FIG. 5 in U.S. patent application Ser. No. 11/397,817, which is incorporated herein by reference.

FIG. 5 depicts flowchart 500 of a method for making a query according to one embodiment of the invention. In an embodiment, the flowchart 500 starts at module 502 where a subscriber initiates a query request. A subscriber may initiate a request using any known and/or convenient methods including, but not limited to, by inputting a request via a communication device such as mobile device 108 in FIG. 1. In one embodiment, the request comprises one or more attribute criteria including, but not limited to, user name, anniversaries, home address, business address, home phone number, home fax number, cell phone number, business phone number, email addresses, wish lists, clothing sizes, favorite colors, favorite foods, and the like. For example, a subscriber may make a query search for all other subscribers who graduated a specific high school and whose favorite food was turkey.

In an embodiment, the flowchart 500 continues at module 504 where a server receives the query request. The server may be any server configured to allow permissions control, including server 102 in FIG. 1. In one embodiment, the query request comprises information including, but not limited to, one or more attribute criteria, a user identification associated with the querying party, attributes associated with the querying party, and the like.

In an embodiment, the flowchart 500 continues at module 506 where the server performs a search using query data. The query data includes a set of search attributes as parameters in a search. For example, search attributes may include, but not limited to, a last name, a home address, a telephone number, an email address, and the like. A query match occurs when a subscriber entry, such those shown in user table 302 of FIG. 3, comprises attributes matching the search attributes. In one embodiment, the server, using the search attributes, performs a database lookup function in a database such as the data stores 214 in FIG. 2. In an embodiment, the entries in a database such as the data stores 214 in FIG. 2 comprises user information such as shown in user table 302 in FIG. 3.

In an embodiment, the flowchart 500 continues at decisions point 508 where it is determined whether any subscriber entry includes attributes matching the search attributes. In one embodiment, the determination is made with a search in a data structure comprising entries such as those illustrated in user table 302 in FIG. 3. If no matching entry is found (508-NO), the querying party is notified that no subscriber matched the query. The notification may be delivered with any known and/or convenient methods including, but not limited to, an IM message, an email message, a text message, and the like. If one or more entries include attributes matching the attribute criteria of the query (508-YES), the flowchart 500 continues at module 510 where the permissions for each matching entry are checked. The permissions may be stored locally at the server or remotely and may be evaluated using any known and/or convenient methods including, but not limited to, the four embodiments for checking permissions discussed with reference to FIG. 1. In one embodiment, a lookup function is performed on one or more data entries such as those shown in the query access table 308 in FIG. 3.

In an embodiment, the flowchart 500 continues at module 512 where a search result is generated according to the permissions evaluation. Whether a subscriber with attributes matching the search attributes will be included in the result depends on the subscriber's permission settings. In one embodiment, a matching subscriber whose permissions bar all queries would not be included in the search result whereas a matching subscriber whose permissions allow queries is always included in the search result. In other embodiments, a subscriber selects additional permission settings to add finer discretionary measure in response to query requests. The additional layers of permissions may include, but are not limited to, privacy settings, response preference settings, and the like. Detailed descriptions of additional permissions follow with reference to FIG. 6. The search result may comprise information associated with one or more subscribers whose attributes match the search attributes. In one embodiment, the search result may include one entry for each subscriber whose attributes match the search attributes and whose permission settings allow a result to be returned to the querying party. Further, each result entry may comprise the same or different content. For example, a subscriber with matching attributes may have selected a default query response comprising a set of predetermined attributes including, but not limited to, name, address, telephone number, email address, internet messaging address, and the like. In another example, a subscriber with matching attributes may be notified of the query and subsequently selects the information disclosed to the querying party including, but not limited to, name, address, telephone number, email address, internet messaging address, and the like. In yet another example, the querying party sends a query request comprising certain presentable attributes associated with the querying party including, but not limited to, name, address, telephone number, email address, internet messaging address, and the like. In this example, a subscriber with matching attributes may choose what response to send based on the querying party's presentable attributes. The search result may be delivered to the querying party using any known and/or convenient methods including, but not limited to, an IM message, an email message, a text message, and the like.

FIG. 6 depicts a flowchart 600 of a method for facilitating subscriber-controlled query responses. In an embodiment, the flowchart 600 starts at module 602 where a server receives a query request. The server may be any server configured to allow permissions control, including server 102 in FIG. 1. In one embodiment, the query request comprises information including, but not limited to, one or more attribute criteria, a user identification associated with the querying party, attributes associated with the querying party, and the like.

In an embodiment, the flowchart 600 continues to module 604 where the server performs a search using the query data. The query data includes a set of search attributes as parameters in a search. For example, search attributes may include, but not limited to, a last name, a home address, a telephone number, an email address, and the like. A query match occurs when a subscriber entry, such as those shown in user table 302 of FIG. 3, comprises attributes matching the search attributes. In one embodiment, the server, using the search attributes, performs a database lookup function in a database such as the data stores 214 in FIG. 2. In an embodiment, the entries in a database such as the data stores 214 in FIG. 2 comprises user information such as that shown in user table 302 in FIG. 3.

In an embodiment, the flowchart 600 continues at decisions point 606 where it is determined whether any subscriber entry includes attributes matching the search criteria. In one embodiment, the determination is made by a search in a data structure comprising entries such as those illustrated in user table 302 in FIG. 3. If no matching entry is found (606-NO), the querying party is notified in module 630 that no subscriber matched the query. The notification may be delivered with any known and/or convenient methods including, but not limited to, an IM message, an email message, a text message, and the like.

Assuming one or more entries include attributes matching the attribute criteria of the query (606-YES), the flowchart 600 continues at module 608 where the permission settings for each matching entry are checked. The permissions may be stored locally at the server or remotely and evaluated using any known and/or convenient methods including, but not limited to, the four embodiments for checking permissions discussed with reference to FIG. 1. In one embodiment, a lookup function is performed on one or more data entries such as those shown in the query access table 308 in FIG. 3.

In an embodiment, the flowchart 600 continues to decision point 610 where it is determined whether a matching subscriber requires searcheable criteria to be met before any result associated with the subscriber can be sent. In one embodiment, the searcheable requirement is a permission setting that controls query access to subscriber information. For example, a subscriber may designate one or more attributes associated with the subscriber as searcheable and a query must include at least one of the one or more searcheable attributes before receiving a result associated with the subscriber. In another example, a subscriber may select the searcheable requirement but designates no searcheable attribute, thereby effectively barring all querying parties from receiving results associated with the subscriber. In yet another example, a subscriber may select the searcheable requirement and designates all attributes associated with the subscriber as searcheable, thereby allowing queries on all attributes. Alternatively, a subscriber may elect not to have a searcheable requirement and allow queries on any and all attributes. A subscriber may select the searcheable preference using any known and/or convenient methods including, but not limited, the mobile devices 108 shown in FIG. 1, a web interface, and the like. A searcheable permission setting may be effected when a subscriber selects or de-selects attributes as searcheable and corresponding searcheability flags and/or bits are switched from 0 to 1 or vice versa in a data entry such as those shown in the query access table 308 of FIG. 3.

Assuming searcheable criteria are required (610-YES), the flowchart 600 continues on decision point 612 where it is determined whether the search attributes includes a searcheable attribute. For example, a subscriber may select last name, telephone number, and email address as searcheable attributes. If a query includes, as search attributes, at least one of the three searcheable attributes, the searcheable criteria are met (612-YES). If the search attributes includes none of the three attributes (612-NO), the flowchart 600 continues on module 618 and the subscriber's information is not included in the search result that the querying party receives.

If the subscriber has elected not to require searcheable criteria (610-NO) or the searcheable criteria are met (612-YES), the flowchart 600 continues on decision point 614 where it is determined whether the matching subscriber requires matcheable criteria to be met. In one embodiment, the matcheable requirement is a subscriber permission setting that subscribers may select to refine control over query access. In one embodiment, a subscriber may designate one or more attributes associated with the subscriber as matcheable criteria which a query must include before the subscriber's information is added to a search result. A subscriber may set an attribute as matcheable including, but not limited to, user name, last name, telephone number, email address, and the like. In one example, a subscriber designates an attribute as matcheable and any search attribute matching the matcheable attribute would meet the matcheable criteria requirement in module 616. In another example, a subscriber designates two or more attributes as matcheable and the search attributes must include attributes that match all the matcheable attributes to meet the matcheable criteria in module 616. In yet another example, a subscriber designates two or more attributes as matcheable, and search attributes that include at least one attribute that matches a matcheable attributes would meet the matcheable criteria in module 616. In other embodiments, a subscriber may designate a number of attributes as matcheable and specify a subset of the matcheable attributes as required. For example, a query would meet the matcheable criteria if the search attributes includes any two attributes in a set of three or more matcheable attributes. A subscriber may select the matcheable preference using any known and/or convenient methods including, but not limited, the mobile devices 108 shown in FIG. 1, a web interface, and the like. A matcheable permission setting may be effected when a subscriber selects or de-selects attributes as matcheable and corresponding matcheability flags and/or bits are switched from 0 to 1 or vice versa in a data entry such as those shown in the query access table 308 of FIG. 3. As shown in the query access table 308, searcheability and matcheability may overlap and an attribute may be used to fulfill both the searcheable criteria in module 612 and the matcheable criteria in module 616.

Assuming matcheable criteria are required (614-YES), the flowchart 600 continues on decision point 616 where it is determined whether the search attributes include one or more attributes an attribute matching the subscriber's matcheable criteria. For example, a subscriber may select last name, telephone number, and email address as matcheable attributes and further requires that all three must be included in a query. If a query includes all three matcheable attributes, the matcheable criteria are met (616-YES). If a query does not include all three matcheable attributes (616-NO), the flowchart 600 continues on module 618 and the subscriber's information will not be included in the search result that the querying party receives.

If the subscriber elects not to require matcheable criteria (614-NO) or the matcheable criteria are met (616-YES), the flowchart 600 continues on decision point 620 where it is determined whether a matching subscriber has selected a private status. In one embodiment, a subscriber elects a private status to maintain ultimate control over query access to subscriber information. In one embodiment, a subscriber having a private status will receive all query requests matching the subscriber's attributes and has discretion as to what information associated with the subscriber, if any, is sent back to the querying party. A subscriber may select the private status using any known and/or convenient methods including, but not limited, the mobile devices 108 shown in FIG. 1, a web interface, and the like. A private status setting may be selected or de-selected when a subscriber selects the private status and a corresponding status flag and/or bit is switched from 0 to 1 or vice versa in a data entry such as those shown in the privacy table 306 of FIG. 3.

Assuming that the matching subscriber has not selected a private status (620-NO), the flowchart 600 continues on module 628 and search results associated with the subscriber is sent to the querying party. In one embodiment, a matching subscriber may have selected a default query response comprising a set of predetermined attributes including, but not limited to, name, address, telephone number, email address, internet messaging address, and the like. In another embodiment, a query specifies the type of information solicited including, but not limited to, a business telephone number, an address, an email address, an IM user name, and the like. In this example, the search results may include the information solicited in the query. In yet another embodiment, a matching subscriber may limit the type of information included in a search result. For instance, the subscriber may only allow a last name, an email address, or an IM user name to be included in a search result. In addition to sending search results, the subscriber may also alter permissions so that the querying party may receive, update, or access one or more attributes associated with the subscriber. For example, the subscriber may add the querying party as a new contact and allow the querying party access to certain individual or group of attributes. Moreover, the subscriber may change permissions such that the querying party may receive updates to attributes associated with the subscriber.

Assuming that the matching subscriber has selected the private status (620-YES), the flowchart 600 continues on module 622 where the subscriber receives notice of the query request. A subscriber may receive the notice through any known and/or convenient methods including, but not limited to, an email, a text message, and the like. In one embodiment, the querying includes attributes associated with the querying party and the notice may present these attributes to the subscriber.

In an embodiment, the flowchart 600 continues on module 624 where the subscriber's response to the notice is received. In one embodiment, the query includes one or more attributes associated with the querying party and the subscriber may decide whether to respond to the query based on these attributes. In another embodiment, the subscriber may receive the notice and reject the query. In yet another embodiment, the subscriber may ignore the query. In the last two embodiments, the querying party may receive notice that a match was found but results are unavailable. Alternatively, the querying party receives no notice that a match was found. In yet another embodiment, rather than sending information associated with the subscriber, the subscriber sends a message requesting additional information associated with the querying party.

In an embodiment, the flowchart 600 continues on decision point 626 where it is determined whether a response associated with the subscriber will be sent to the querying party. If the subscriber chooses not to send a response (626-NO), no information associated with the subscriber will be sent to the querying party. In another embodiment, the querying party may receive a notice that a match was found but results are unavailable.

Assuming the subscriber chooses to send a response (626-YES), the querying party will receive information associated with the subscriber. In one embodiment, the subscriber chooses to send a default set of attributes to the querying party including, but not limited to, an address, an email address, a first name, an IM user name, and the like. In another embodiment, the subscriber sends a message requesting additional information associated with the querying party. The message may include some information associated with the subscriber but the querying party may receive additional information associated with the subscriber only if the querying party responds to the subscriber's message. For example, the subscriber may send a first name as a response but will disclose additional information only if the querying party reveals the high school the querying party attended. Alternatively, the querying party may receive only a message soliciting for additional information associated with the querying party and the subscriber will make further decisions when the querying party responds to the message. For example, the subscriber may request that the querying party's address be sent to the subscriber before the subscriber will decide whether the querying party may receive the subscriber's email address. A response may be sent using any known and/or convenient methods including, but not limited to, a web interface, an email message, a text message, and the like. In addition to sending search results, the subscriber may also alter permissions so that the querying party may receive, update, or access one or more attributes associated with the subscriber. For example, the subscriber may add the querying party as a new contact and allow the querying party access to certain individual or group of attributes. Moreover, the subscriber may change permissions such that the querying party may receive updates to attributes associated with the subscriber.

FIG. 6 is an illustrative rather than limiting embodiment. The query access control variables characterized as searcheable, matcheable, and private serve only to show some embodiments where a subscriber maintains different levels of control over query access. Other access control methods may be implemented. For example, a subscriber may select a visible profile whereby information associated with the subscriber is freely accessible to all queries. In another example, a subscriber with a private status may designate one or more attributes to serve as keys whereby a query matching a key may have direct access to attributes associated with the subscriber. In one embodiment where a subscriber with a private status receives numerous query notices, the subscriber may designate one or more attributes as keys whereby a query matching a key will have notice priority over other query notices. That is, regardless of the normal sequence with which the subscriber receives query notices, the subscriber will receive the notice for a query matching a key prior to receiving other query notices. For example, the subscriber may select mother's maiden name as a key and any query matching that attribute will have notice priority over other queries. It will be recognized by one skilled in the art that methods for controlling query access to subscriber information are numerous. An exhaustive list of all combinations and permutations of embodiments has not been attempted here but one skilled in the relevant will recognize alternative embodiments based on those methods described above.

Although modules 606 to 628 in FIG. 6 were discussed in conjunction with a singular matching entry and an individual subscriber associated with the entry, it is understood that the process performed in those modules are iterative for each matching entry. In one embodiment, the search result for each matching entry/subscriber, if any, is sent to the querying party serially as results become available. In another embodiment, the search result for each matching entry/subscriber, if any, is stored remotely or locally in data storage and sent in an aggregate form when the query search is complete.

FIG. 7 depicts an exemplary system on which a framework for subscriber-controlled queries may be implemented. FIG. 7 depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 704 is typically at least one computer system which operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a form of a media database. While two computer systems 704 and 706 are shown in FIG. 7, the web server system 704 and the server computer system 706 can be one computer system having different software components providing the web server functionality and the server functionality provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be ethernet network or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 7 depicts a computer system 740 for use in the system 700. The computer system 740 may be a conventional computer system that can be used as a client computer system or a server computer system or as a web server system. Such a computer system can be used to perform many of the functions of an Internet service provider, such as ISP 710.

In the example of FIG. 7, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, ISDN modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. One of skill in the art will immediately recognize that the terms “machine-readable medium” or “computer-readable medium” includes any type of storage device that is accessible by the processor 748 and also encompasses a carrier wave that encodes a data signal.

Objects, methods, inline caches, cache states and other object-oriented components may be stored in the non-volatile storage 756, or written into memory 752 during execution of, for example, an object-oriented software program. In this way, the components illustrated in, for example, FIGS. 1-6 can be instantiated on the computer system 740.

The computer system 740 is one example of many possible computer systems which have different architectures. For example, personal computers based on an Intel microprocessor often have multiple buses, one of which can be an I/O bus for the peripherals and one that directly connects the processor 748 and the memory 752 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 752 for execution by the processor 748. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or, advantageously, it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

While this invention has been described by way of example in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

1. A method, comprising:
maintaining one or more attribute sets associated with one or more users, wherein each attribute set of the one or more attribute sets comprises one or more attributes associated with one user of the one or more users;
maintaining one or more permission sets associated with the one or more users, wherein each permission set of the one or more permissions sets comprises one or more permissions associated with one user of the one or more users;
receiving a query request having one or more search attributes from a first user;
searching the one or more attribute sets using the one or more search attributes;
locating an attribute set having attributes that match the search attributes, wherein the attribute set is associated with a second user;
checking a permission set associated with the second user:
if the permission set associated with the second user allows the first user to query the second user using the search attributes, sending a response to the first user, and
if the permission set associated with the second user denies the first user query access using the search attributes, rejecting the query request.

2. The method as recited in claim 1, wherein the query request comprises one or more attributes associated with the first user.

3. The method as recited in claim 1, wherein, if the permission set associated with the second user allows the first user to query the second user using the search attributes, the first user receives a predetermined response comprising one or more attributes associated with the second user.

4. The method as recited in claim 1, wherein, if the permission set associated with the second user allows the first user to query the second user using the search attributes, the first user receives content generated by the second user.

5. The method as recited in claim 1, wherein, if the permission set associated with the second user denies the first user query access using the search attributes, sending the first user a notice that the query request has been denied.

6. The method as recited in claim 1, further comprising, before the checking step, the step of setting a private preference as one of the one or more permissions associated with the second user.

7. The method as recited in claim 6, further comprising the step of notifying the second user of the query request from the first user.

8. The method as recited in claim 7, further comprising the step of determining whether the first user will receive a response from the second user.

9. The method as recited in claim 8, further comprising the step of receiving a response from the second user.

10. The method as recited in claim 1, wherein the one or more permissions associated with the second user designate one or more attributes of the attributes associated with the second user as attributes with which a query can be performed.

11. The method as recited in claim 10, further comprising the step of checking whether the search attributes include one or more of the attributes with which the query can be performed:
if the search attributes include one or more of the attributes with which the query can be performed, the query proceeds; and
if the search attributes does not include one or more of the attributes with which the query can be performed, the query request is denied.

12. The method as recited in claim 1, wherein the one or more permissions associated with the second user designate one or more attributes of the attributes associated with the second user as attributes that are required for a query.

13. The method as recited in claim 12, further comprising the step of checking whether the search attributes include one or more of the attributes that are required:
if the search attributes include one or more of the attributes that are required, the query proceeds; and
if the search attributes does not include one or more of the attributes that are required, the query request is denied.

14. A method, comprising:
maintaining a set of attributes associated with a user;
maintaining a set of permissions associated with the user;
setting one or more permissions in the set of permissions associated with the user to control query access to the set of attributes associated with the user.

15. A system, comprising:
a database for storing one or more attribute sets associated with one or more users and one or more permission sets associated with the one or more users; and
a server, wherein the server is capable of receiving a query request having one or more search attributes, searching the database for one or more attribute sets matching the search attributes, and checking the permission sets associated with users whose attribute sets match the search attributes.

16. The system as recited in claim 15, wherein each permission set of the one or more permission sets comprises one ore more permissions.

17. The system as recited in claim 15, further comprising a second database for storing the one or more permissions sets associated with the one or more users.

18. The system as recited in claim 15, further comprising a permissions setting module capable of adding or editing permissions in the one or more permission sets.

19. The system as recited in claim 15, further comprising a set of clients associated with a user, wherein the user can manage the one or more permissions associated with the user through one or more clients from the set of clients.

20. The system as recited in claim 19, wherein a client in the set of clients is a web interface.

21. The system as recited in claim 19, wherein a client in the set of clients is a mobile phone.

22. A system, comprising:
an interface for setting one or more permissions associated with a user;
a permissions setting module for managing the one or more permissions associated with the user; and
a query control module for regulating, according to the permissions associated with the user, access to one or more attributes associated with the user.

23. The system as recited in claim 22, further comprising a query processing module for receiving a query request and searching, using query data, for query matches in one or more attribute sets associated with one or more users.
